(19) United States
(12) Patent Application Publication
(10) Pub. No.: US 2004/0105972 A1
(43) Pub. Date: Jun. 3, 2004

(54) Coated reshaped aluminum semi-finished products and/or components and method for the production thereof

(76) Inventors: Dieter Lehmann, Coswig (DE); Michaela Gedan-Smolka, Ortrand (DE)

Correspondence Address: GREENBLUM & BERNSTEIN, P.L.C., 1950 ROLAND CLARKE PLACE, RESTON, VA, 20191, US

(21) Appl. No.: 10/471,582

(22) PCT Filed: Mar. 12, 2002
(86) PCT No.: PCT/DE02/00924

(30) Foreign Application Priority Data
Mar. 13, 2001 (DE) 10112991.2

(51) Int. Cl. B05D 1/18; B05D 1/12; B32B 15/08

(52) U.S. Cl. 428/328; 427/431; 427/180

(57) ABSTRACT

The invention relates to the field of chemistry and concerns coated reshaped aluminum semi-finished products and/or components which are coated with a two-step hardening/cross-linking coating agent and a method for the production thereof. The aim of the invention is to disclose and to produce coated reshaped aluminum semi-finished products and/or components which as semi-finished products can still be re-shaped and hardened at high temperatures. The object is attained through coated reshaped aluminum semi-finished products and/or components which are coated with an at least two-step hardening/cross-linking coating agent and at most partially hardened/cross linked, and the formed coating film is elastic. The object is also attained through a method in which aluminum semi-finished products and/or components are coated with at least one coating agent and the layer(s) in a first step are covered with film and partially hardened/partially cross-linked and substantially hardened/cross-linked in an at least second step during and/or after at least one reshaping process.

The invention relates to the fields of chemistry, mechanical engineering, and materials engineering and concerns coated reshaped aluminum semi-finished products and/or components that are coated with a two-step hardening/cross-linking coating agent for a stable coating during reshaping, and a method for their production.

In order to be able to apply lacquer coat systems to aluminum semi-finished products (sheet metal) and to realize them with the properties demanded today, such as high scratch-resistance, a high degree of gloss, environmental compatibility, and a high utilization factor, the commercially used coating powder systems are industrially fired at temperatures between 160 and 220° C. As a result, the base material aluminum stiffens or severely embrittles in these temperature ranges through post-crystallization and is no longer suitable for a further reshaping processing.

DE 198 56 878/WO 00/34355 describes hardening masses containing uretdione groups that can be hardened in two-step reactions. The first step preferably proceeds by way of an allophanate formation of less than 160° C. From temperatures greater than 170° C. urethane compounds are formed during the development of the cross-linked final state.

DE 198 56 877/WO 00/34391 describes “hardening masses” preferably used for the production of coating powders and the methods for producing and processing them, which masses are used in a targeted manner for multiple-step reactions and preferably for two-step reactions. These masses harden in multiple-step reactions, whereby the first step takes place catalyzed at low temperatures.

A disadvantage with the known coatings is that essentially no coating can be achieved which remains stable during reshaping.

The object of the invention is to specify and produce coated reshaped aluminum semi-finished products and/or components that can still be reshaped as semi-finished products, whereby a closed coating is maintained, and hardened at high temperatures so that in the end a closed coating is likewise obtained.

The object is attained by the invention disclosed in the claims. Further developments are the subject matter of the subclaims.

The coated reshapable aluminum semi-finished products and/or components according to the invention are coated with an at least two-step hardening/cross-linking coating agent in the form of a hot melt coating mass or as a coating powder or as a lacquer dispersion or as a solvent system, and are at most partially hardened/partially cross-linked. The coating film formed is elastic and is present essentially as a sealed coating film during the subsequent reshaping processes.

The further coated aluminum semi-finished products and/or components according to the invention are provided with at least one coating film essentially hardened/cross-linked in at least a second reaction step after a reshaping process, whereby the hardening/cross-linking takes place under the conditions of the post-crystallization of the aluminum (alloy).

The coated reshapable aluminum semi-finished products and/or components are advantageously present in the form of thin aluminum sheet(s) or aluminum pipe(s) or aluminum sandwich semi-finished product(s) in sheet or pipe form made of reshapable aluminum (alloys), which are reshapable at temperatures less than 150° C.

The coated reshapable aluminum semi-finished products and/or components are also advantageously coated with the coating film completely or partially or on one side or on the inside or on the outside.

It is also advantageous for the coated reshapable aluminum semi-finished products and/or components to be provided with at least one further layer.

It is likewise advantageous if the adhesion with the coated reshapable aluminum semi-finished products and/or components is obtained through adhesive interactions and/or through chemical, preferably covalent, bonds.

It is also advantageous if with the coated reshapable aluminum semi-finished products and/or components at least the one coating agent comprises a binder system which is composed of one or more resin and hardening component(s), with or without additive(s) and/or catalyst(s).

With the method according to the invention for producing coated reshapable aluminum semi-finished products and/or components, aluminum semi-finished products in the form of thin aluminum sheet or aluminum sandwich components or aluminum pipe of reshapable aluminum (alloy) and/or aluminum components are coated with at least one coating agent in the form of a hot melt coating mass or a coating powder or a coating dispersion or a solvent system. In a first step the layer(s) are made into a film and partially hardened/partially cross-linked and in an at least second step they are essentially hardened/cross-linked during and/or after at least one reshaping process.

The first step for film formation and partial hardening/partial cross-linking is advantageously carried out at temperatures≦150° C.

Also advantageously, a temperature/time regime is set to maintain the reshaping capability of the aluminum semi-finished products and/or components after the first step for film formation and partial hardening/partial cross-linking of the layer.

Moreover, it is advantageous for the partial hardening/partial cross-linking to be carried out thermally and/or photochemically and/or radiochemically.

It is also advantageous if the second step for hardening/cross-linking is carried out at temperatures>130° C.

It is furthermore advantageous for the second step for hardening/cross-linking is carried out during and/or after at least one reshaping process under the conditions of the post-crystallization of the aluminum (alloy).

It is also advantageous for the coated reshaped aluminum semi-finished products and/or components to be coated with at least one further layer and made into a film in the at least second step and hardened/cross-linked together with the first (lacquer) layer.

The essence of the invention lies in the production of coated reshaped aluminum semi-finished products and components that are coated after the aluminum semi-finished product production and are made into a film and partially hardened/partially cross-linked in a thermal process. The partial hardening/partial cross-linking of the layer, for example, thermally and radiochemically or only thermally, features such a mechanical stability that these semi-finished products can be temporarily stored without any problems and at a later point in time processed further. To maintain the reshaping capability of the aluminum semi-finished products and components, a corresponding temperature/time regime must be followed in the first step of film formation and partial hardening/partial cross-linking. It is thereby necessary for shorter reaction times to be chosen at higher temperatures. At lower temperatures, for example, the partial hardening/partial cross-linking can be carried out radiochemically.

The elasticity of the partially hardened/partially cross-linked (lacquer) layer can be adjusted through criteria—first, through the composition of the binder system and, second, through the degree of partial hardening/partial cross-linking that can be determined by means of DSC measurements. With respect to the composition of the binder system in particular elastic structural elements can be integrated into the resin components. The (lacquer) film formed is thus present during or after the reshaping process as a sealed (lacquer) film, as a result of which, in particular, additional procedural steps can be omitted.

After the reshaping process further layers, for example, top coats, cover or color layers or sliding layers can be applied, which can also be hardened/cross-linked in the second step at temperatures greater than 130° C. The rigidity of the component is attained with the hardening/cross-linking of the layer(s) under the conditions of the post-crystallization of the aluminum (alloy).

In addition to the adhesive interaction, the adhesion between the reshapable aluminum semi-finished products and components and the layer and between the layers is advantageously obtained through chemical bonds. A further improved adhesion is obtained through the formation of covalent bonds. Through the partial hardening/partial cross-linking of a layer, functional and/or reactive groups, which enter into a covalent bond with the functional and/or reactive groups of another layer, remain on the surface.

The invention is explained in greater detail below on the basis of several exemplary embodiments.

### EXAMPLES

Compounds (A) and (B) are homogenized in a laboratory kneader at a mass temperature of 90° C. The compounds (E), (D), and (C) are added to this mass one after the other.

The compositions of the example mixtures are specified in table 1. The homogenized masses are quenched by being placed in liquid nitrogen. These masses are processed further to a coating powder in a (laboratory) grinding plant with a separator.

TABLE 1
Composition of the example mixtures*

| | 1 | | | |
|---|---|---|---|---|
| Components/example | (comparison) | 2 | 3 | 4 |
| (A) | 75.7 | 74.7 | 74.7 | 74.1 |
| Hydroxyl-terminated | | | | |
| polyester | | | | |
| (B) | 24.3 | 24.3 | 24.3 | 24.3 |
| Polyaddition | | | | |
| compound containing | | | | |
| uretdionegroups | | | | |
| (C) | — | 1.0 | — | — |
| Dibutyltin dibutyrate | | | | |
| (D) | — | — | 1.0 | 1.0 |
| Zinc acetylacetonate | | | | |
| (E) | — | | | 0.6 |
| Acronal 4F | | | | |

*All data are in percentage by weight.

The coating powder is applied to a thin aluminum sheet by means of a coating powder finishing and made into a film for 15 minutes in a forced-air oven at 140° C. and partially hardened/partially cross-linked. It was determined through DSC measurements that under isothermal measurement conditions no further reactions of uretdione to allophanate are detectable.

By using deep drawing, the coated thin aluminum sheet is shaped at room temperature into a cup as a model component. No formation of cracks or damage to the layer thereby occurred and a sealed coating film was present.

After a clear coating powder is applied as a top coat, this model component is hardened/cross-linked in a forced-air oven at 170° C. for 20 minutes. At the same time the rigidity of the component is increased through post-crystallization.

The characterization of the degree of cross-linking of the lacquer layers is carried out by means of differential scanning calorimetry (DSC). In the dynamic DSC scan of 40 to 220° C. at a heating-up rate of 10 K/min, a reaction peak could no longer be detected. The results are set forth in table 2.

TABLE 2
Results of the thermal tests

| | 1 | | | |
|---|---|---|---|---|
| Example | (comparison) | 2 | 3 | 4 |
| Start of the reaction | 184 | 132 | 130 | 125 |
| Tₒₙₛₑₜ (° C.) | | | | |
| Maximum reaction | 212 | 161 | 143 | 141 |
| Tₘₐₓ (° C.) | | | | |

Example 1 in the tables is the comparison example analogous to commercial coating agents, in which the aluminum semi-finished product is no longer reshapable after the coating and partial hardening/partial cross-linking.

1. Coated reshapable aluminum semi-finished products and/or components that are coated with an at least two-step hardening/cross-linking coating agent in the form of a hot melt coating mass or as a coating powder or as a lacquer dispersion or as a solvent system, and are at most partially hardened/partially cross-linked, and the formed coating film is elastic and is present essentially as a closed coating film during the subsequent reshaping processes.

2. Coated aluminum semi-finished products and/or components with at least one coating film essentially hardened/cross-linked in at least a second reaction step after a reshaping process, whereby the hardening/cross-linking takes place under the conditions of the post-crystallization of the aluminum (alloy).

3. Coated reshapable aluminum semi-finished products and/or components according to claim 1, which are present in the form of thin aluminum sheet(s) or aluminum pipe(s) or aluminum sandwich semi-finished product(s) in sheet or pipe form made of reshapable aluminum (alloys), which are reshapable at temperatures less than 150° C.

4. Coated reshapable aluminum semi-finished products and/or components according to claim 1 or 2, which are coated with the coating film completely or partially or on one side or on the inside or on the outside.

5. Coated reshapable aluminum semi-finished products and/or components according to claim 1, in which the coated aluminum semi-finished products and/or components are provided with at least one additional layer.

6. Coated reshapable aluminum semi-finished products and/or components according to claim 1 or 2, in which the adhesion is obtained through adhesive interactions and/or through chemical, preferably covalent, bonds.

7. Coated reshapable aluminum semi-finished products and/or components according to claim 1 or 2, with which at least the one coating agent comprises a binder system which is composed of one or more resin and hardening component(s), with or without additive(s) and/or catalyst(s).

8. Method for the production of coated reshapable aluminum semi-finished products and/or components according to claim 1 or 2, in which the aluminum semi-finished products in the form of thin aluminum sheets or aluminum sandwich components or aluminum pipe made of reshapable aluminum (alloy) and/or aluminum components are coated with at least one coating agent in the form of a hot melt coating mass or coating powder or lacquer dispersion or solvent system, and the layer(s) are formed into a film and partially hardened/partially cross-linked in a first step, and are essentially hardened/cross-linked in an at least second step during and/or after at least one reshaping process.

9. Method according to claim 8, in which the first step for film formation and partial hardening/partial cross-linking is carried out at temperatures≦150° C.

10. Method according to claim 8, in which a temperature/time regime is set to maintain the reshaping capability of the aluminum semi-finished products and/or components after the first step for film formation and partial hardening/partial cross-linking of the layer.

11. Method according to claim 8, in which the partial hardening/partial cross-linking is carried out thermally and/or photochemically and/or radiochemically.

12. Method according to claim 8, in which the second step for hardening/cross-linking is carried out at temperatures>130° C.

13. Method according to claim 8, in which the second step for hardening/cross-linking is carried out during and/or after at least one reshaping process under the conditions of the post-crystallization of the aluminum (alloy).

14. Method according to claim 8, in which the coated reshaped aluminum semi-finished products and/or components are coated with at least one further layer and in the at least second step are formed into a film and are hardened/cross-linked together with the first (lacquer) layer.
